(19) United States
(12) Patent Application Publication
(10) Pub. No.: US 2020/0286172 A1
(43) Pub. Date: Sep. 10, 2020

(54) METHODS AND APPARATUSES FOR TRADING COMBINATIONS OF FINANCIAL INSTRUMENTS

(71) Applicant: NASDAQ TECHNOLOGY AB, Stockholm (SE)

(72) Inventor: Staffan LANTZ, Stockholm (SE)

(21) Appl. No.: 16/618,234

(22) PCT Filed: May 30, 2018
(86) PCT No.: PCT/SE2018/050541

§ 371 Date: Nov. 29, 2019

Related U.S. Application Data
(60) Provisional application No. 62/514,170, filed on Jun. 2, 2017.

(51) Int. Cl. G06Q 40/04; G06Q 40/06

(52) U.S. Cl. CPC G06Q 40/04; G06Q 40/06

(57) ABSTRACT

The present disclosure relates to automated exchange systems. In particular, the present disclosure relates to automated exchange systems configured for combination trading. Among other things, the present disclosure presents a computer-implemented method for trading combinations of financial instruments. The method may comprise i) receiving a combination order to trade financial instruments; ii) processing the received combination order with an extended gcd algorithm to determine whether there exists a general solution for the received combination of financial instruments; iii) storing the received combination order as an eligible combination order for subsequent matching when it is determined that thereexists a general solution for the received combination of financial instruments; elseiv) cancelling the received combination order when it is determined that there does not exist a general solution for the received combination of fiancial instruments.

### TECHNICAL FIELD

This disclosure relates to electronic exchange systems. Electronic exchange systems are sometimes referred to as computer-implemented exchange systems because the exchange may be implemented by means of one or several computers.

In particular, the disclosure relates to automated exchange systems configured for trading of combination instruments.

In some aspects, the disclosure relates to methods and apparatuses in an electronic exchange system for the validation of so called combination order data messages.

In some aspects, the disclosure relates to methods and apparatuses in an automated electronic exchange system for the generation of estimated parameters indicative of price levels of financial instruments for a trade in a combination of financial instruments.

### BACKGROUND

In so-called package, or combination, trading, also known as combo trading, a trader places, on a market venue, a single price to trade a specific combination of different financial instruments. These different financial instruments can be stock shares, derivatives, options, bonds etc. or any combinations thereof. A combination order could for example be “Sell two lots of instrument A, and buy three lots of instrument B for a combination price of $100”.

A combination order is typically listed as a single item on the market venue. Thus, in order for a combination order to be executed, all the involved instruments must be traded as a single order. The combination instrument could be a tailor made combination (TMC) or a standard combination. A strategy is the specific relationship between the different financial instruments making up the combination. The number of different instruments, or so-called legs, could vary from two, as in the example above, up to four or even more.

When a combination order has been executed, the prices for the different instruments traded, the so-called leg prices, are typically determined. In the above given example, one leg price for the instrument A and another leg price for the instrument B are determined. One reason for the need to determine leg prices is that different instruments could have been traded for different clients of the broker. Another reason could be that that the leg prices should be booked on different accounts. Yet another reason could be that a clearing house only accepts trades in the legs.

In an automated exchange system configured for combination trading, a major bottleneck may be the matching unit, where the matching of orders typically takes place. As an example, in certain scenarios the ratio of the volumes cannot be set as natural numbers regardless of the pricing mechanism used. A conventional way of increasing the processing power in the matching unit is to partition the execution into two or several partitions each operating on a different set of data. For example one partition may operate on data for a first type of financial instruments whereas another partition operates on data for a second type of financial instruments. However, such a solution will not work if the matching unit is to match combination orders and generate derived orders because different legs of the order may be processed in different partitions. This is because the matching process calculates the prices as well as the volumes of the derived orders. Hence, it is not possible to have combinations of instruments belonging to two different partitions as simultaneous execution of all legs cannot be guaranteed.

Moreover, it is not a straightforward task to generate accurate leg prices, which in turn may help traders to perform better trades, i.e. leg prices that are current and reflect market trends.

### SUMMARY

It is in view of the above background and other considerations that the various embodiments of the present disclosure have been made.

In view of the above, it is therefore a general object of the aspects and embodiments described throughout this disclosure to provide a solution to improve upon existing automated exchange systems.

This general object has been addressed by the appended independent claims. Advantageous embodiments are defined in the appended dependent claims.

According to a first aspect, there is provided a computer-implemented method for trading combinations of financial instruments.

The method comprises receiving an electronic combination order data message to trade the financial instruments indicated therein. The received electronic combination order data message is processed with an extended greatest common divisor (gcd) algorithm to determine whether there exists a general solution for the received combination of financial instruments. The received electronic combination order data message is stored as an eligible electronic combination order data message for subsequent matching by the matching engine when it is determined that there exists a general solution for the received combination of financial instruments. Else, the received electronic combination order data message is cancelled, when it is determined that there does not exist a general solution for the received combination of financial instruments.

In one embodiment, the method further comprises extracting, from the stored electronic combination order data message, quality parameter(s) for each one of the N legs of the combination order message. A priority order for the subsequent processing of the N legs is determined on the basis of the extracted quality parameter(s); and the N legs are processed in sequential order in accordance with the determined priority order, generating an estimated leg price for each one of the N legs.

In one embodiment, the quality parameter(s) comprises one or more of the following: a price parameter, a spread parameter. The price parameter may for example include a theoretical price, a seed price, a National Bid Offer (NBO) and/or a National Best Bid Offer (NBBO). The spread parameter may for example include a theoretical spread or an estimated spread.

In one embodiment, the method is implemented in a matching unit of an automated electronic exchange system.

In another embodiment, the method is implemented in a distributed network of computing devices. The method steps a) trough d) may then for example be performed by one computing device and the method steps e) through g) may be performed by one or more other computing devices.

According to a second aspect, there is provided an apparatus for trading combinations of financial instruments.

The apparatus comprises a communications interface, a processor, and a memory comprising instructions executable by the processor whereby the apparatus is operative to receive, via the communications interface, an electronic combination order data message to trade financial instruments; and process, by the processor, the received electronic combination order data message with an extended greatest common divisor (gcd) algorithm to determine whether there exists a general solution for the received combination of financial instruments. The apparatus is operative to store, by a memory, the received electronic combination order data message as an eligible combination order for subsequent matching when it is determined that there exists a general solution for the received combination of financial instruments; else cancel, by the processor, the received electronic combination order data message when it is determined that there does not exist a general solution for the received combination of financial instruments.

In one embodiment the communications interface comprises a transmitter (Tx) and/or a receiver (Rx). In another embodiment, the communications interface comprises a transceiver (Tx/Rx).

In one embodiment, the memory additionally comprises instructions executable by the processor whereby the apparatus is operative to extract, by the processor, from the stored electronic combination order data message, quality parameter(s) for each one of the N legs of the combination order. The apparatus is operative to determine, by the processor, a priority order for the subsequent processing of the N legs on the basis of the extracted quality parameter(s); quality parameter(s) for each one of the N legs of the combination order; and processing, by the processor, the N legs in sequential order in accordance with the determined priority order to generate an estimated leg price for each one of the legs of the N legs.

In one embodiment, the apparatus is implemented as a matching unit of an automated exchange system.

According to a third aspect, there is provided a non-transitory computer readable storage medium storing one or more sets of instructions for causing a processor to perform the method according to the first aspect.

### BRIEF DESCRIPTION OF DRAWINGS

These and other aspects, features and advantages will be apparent and elucidated from the following description of various embodiments, reference being made to the accompanying drawings, in which:

FIG. 1 shows a flow chart describing a method according to one example embodiment;

FIG. 2 shows an electronic automated exchange system according to one embodiment; and

FIG. 3 illustrates a computer-readable medium according to one embodiment.

### DESCRIPTION

The present invention will now be described more fully hereinafter. The present invention may, however, be embodied in many different forms and should not be construed as limited to the embodiments set forth herein; rather, these embodiments are provided by way of example so that this disclosure will be thorough and complete, and will fully convey the scope of the invention to those persons skilled in the relevant art. Like reference numbers refer to like elements throughout the description.

It is with respect to above considerations and others that the embodiments of this disclosure have been made.

It is therefore a general object of embodiments to improve upon existing automated exchange systems.

It is a further object to allow for a reduced processing load on the matching unit of an automated exchange system. For example, it would be advantageous to reduce or minimize the number of complex operations performed by the matching unit.

It is a further object to allow for coping with real-time constraints of order matching in automated exchange systems, which require complex operations related to the matching of combination of financial instruments.

It is a further object to allow for an improved generation of estimated prices of financial instruments for a trade in a combination of financial instruments. For example, it would be advantageous to allow for an improved generation of leg prices in combination orders involving several legs. It would be particularly advantageous to allow for an improved generation of leg prices in combination orders involving numerous (e.g., more than three) legs, which may have different ratios in the combination.

The embodiments described herein are based on a notion made by the inventor that an extended Greatest Common Divisor (GCD) algorithm may be advantageously applied during the execution of trading of combination orders. GCD and Extended GCD are known in the existing art of mathematics per se and will therefore not be explained in further detail herein.

The inventor has, however, realized that a combination order can be described in terms of coefficients of the financial instruments it includes. An example of a combination order having two financial instruments may for example be expressed by the following formula:

a*x+b*y=c

The numbers a, b, x, y and c are all integer numbers. This formula has a solution if d=gcd (a,b) divides c. By applying an extended gcd algorithm three numbers can be found such that (d, s, t)=extgcd(a,b). From there these numbers a general solution can be found as:

x=kₓ*v+mₓ, where kₓ=b/d, mₓ=s*c/d

y=k_{y}*v+m_{y} where k_{y}=−a/d, m_{y}=t*c/d

Using these equations, and the allowed intervals for x and y it is further possible to find i) allowed values for v, which in turn gives ii) allowed values for x and y. As will be appreciated, formulas with more variables, e.g. a₀*x₀+a₁*x₁+ . . . +aₙ*xₙ=c, may be solved in a similar way using factorization and recursion.

The inventor has realized that when applying an extended gcd algorithm on a received electronic combination order it is possible to determine, or otherwise check, whether a general solution exists for the received combination of financial instruments.

In a first of its aspects, the present disclosure presents a computer-implemented method for trading combinations of financial instruments, the method comprising:
a) receiving an electronic combination order data message to trade the financial instruments indicated therein;
b) processing the received electronic combination order data message with an extended gcd algorithm to determine whether there exists a general solution for the received combination of financial instruments;
c) storing the received electronic combination order data message as an eligible electronic combination order data message for subsequent matching by the matching engine when it is determined that there exists a general solution for the received combination of financial instruments; else
d) cancelling the received electronic combination order data message when it is determined that there does not exist a general solution for the received combination of financial instruments.

In other words, received electronic combination order data messages are only stored (and accepted, or otherwise validated) as an eligible combination order for subsequent matching when it is determined that there in fact exists a general solution for the received combination of financial instruments. Else, the received combination order is cancelled, or otherwise rejected. Hereby, the computer-implemented method will only store those combination orders which have a general solution and which subsequently can be matched appropriately. By cancelling all other received electronic combination order data messages, the usage of processing resources can be limited. As a consequence, it is possible to reduce the overall processing load.

Furthermore, by allowing subsequent processing of only eligible combination orders it is possible to reduce the risk of matching combination orders at inaccurate pricing levels. Therefore, traders are generally not exposed to the risk of matched combination orders at disadvantageous pricing levels and the quality of service for trading can improve.

As will be appreciated, the above-mentioned method contributes a validation of combination orders.

In an advantageous embodiment, the above-mentioned method is implemented in a matching unit (sometimes referred to as matching engine) of an automated electronic exchange system.

In some embodiments, the method further comprises:
e) extracting, from the stored electronic combination order data message, quality parameter(s) for each one of the N legs of the combination order message;
f) determining a priority order for the subsequent processing of the N legs on the basis of the extracted quality parameter(s); and
g) processing the N legs in sequential order in accordance with the determined priority order, generating an estimated leg price for each one of the N legs.

The above-mentioned number N may be any integer of 1, 2, 3, 4, . . . , N. The higher N is, the more important the determination of priority order may become.

The above-mentioned quality parameter(s) may be any parameter indicating a quality of the leg in question. To this end, the quality parameter(s) may comprise one or more of the following examples: a price parameter, a spread parameter. The price parameter may for example include a theoretical price, a seed price, a National Bid Offer (NBO) and/or a National Best Bid Offer (NBBO). The spread parameter may include a theoretical spread, or an estimated spread. As used herein, spread is used to mean the price gap between a best-selling price and a best buying price (i.e., bid/ask).

The determination of leg price per se for each one of the N legs may be done in accordance with known techniques, such as leg price determining methods developed by NASDAQ. As a mere example, it is possible to utilize any of the combination leg price generation methods described in U.S. Pat. No. 7,698,205.

By determining a certain priority order of the stored (eligible) combination order, it may be possible to process all N legs relatively quickly to generate, or otherwise, determine the respective estimated leg prices. This may thus allow for an increasingly expedited generation of leg prices for N legs, especially when the combination orders are complex combination orders involving numerous legs.

In some embodiments, the above-mentioned method steps e), f) and g) may be performed by a matching unit of the automated electronic exchange system.

In alternative embodiments, however, it is not necessary that the method steps e), f) and g) are performed by a matching unit of the automated exchange system. Instead, one or more of the method steps e), f) and g) can be performed by one or other devices or units that are separate and distinct from the matching unit. For example, the above-mentioned method can be implemented in a distributed network of computing devices, such as e.g. in a Gateway device. As an example, method steps a) through d) could be performed by one computing device (e.g., a matching unit) and method steps e) through g) could be performed by one or more other computing devices (e.g., devices dedicated to combination order matching).

In a second of its aspects, the present disclosure presents an apparatus for trading combinations of financial instruments, wherein the apparatus is operative to perform the method of the first aspect described hereinabove.

An example apparatus comprises a communications interface, a processor; and a memory comprising instructions executable by the processor whereby the apparatus is operative to:
a) receive, via the communications interface, an electronic combination order data message to trade financial instruments;
b) processing, by the processor, the received electronic combination order data message with an extended gcd algorithm to determine whether there exists a general solution for the received combination of financial instruments;
c) storing, by a memory, the received electronic combination order data message as an eligible combination order for subsequent matching when it is determined that there exists a general solution for the received combination of financial instruments; else
d) cancelling, by the processor, the received electronic combination order data message when it is determined that there does not exist a general solution for the received combination of financial instruments.

The communications interface may comprise a transmitter (Tx) and/or a receiver (Rx). Alternatively, the communications interface may comprise a transceiver (Tx/Rx) combining transmission and reception capabilities.

In one embodiment, the memory may additionally comprise instructions executable by the processor whereby the apparatus is operative to:
e) extracting, by the processor, from the stored electronic combination order data message, quality parameter(s) for each one of the N legs of the combination order;
f) determining, by the processor, a priority order for the subsequent processing of the N legs on the basis of the extracted quality parameter(s); quality parameter(s) for each one of the N legs of the combination order
g) processing, by the processor, the N legs in sequential order in accordance with the determined priority order to generate an estimated leg price for each one of the legs of the N legs.

In some embodiments, the apparatus may be implemented as a matching unit of an automated exchange system.

In a third of its aspects, the present disclosure presents a non-transitory computer readable storage medium storing one or more sets of instructions for causing a processor to perform the method according to above-mentioned first aspect.

In the following description, for purposes of explanation and not limitation, specific details are set forth such as particular architectures, interfaces, techniques, etc. in order to provide a thorough understanding of conceived embodiments of the present disclosure.

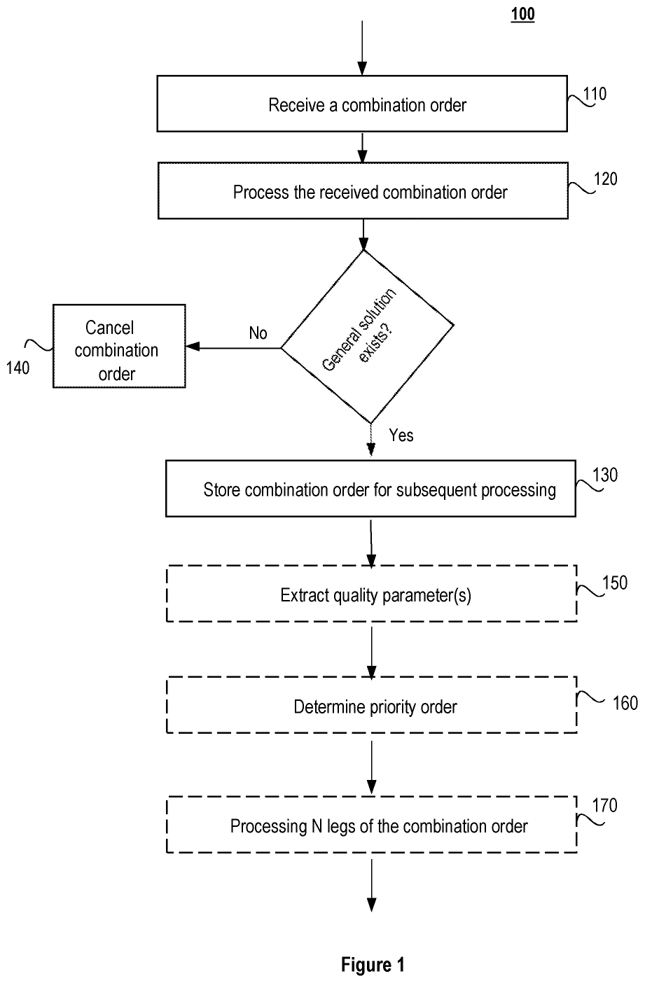

FIG. 1 is a flow chart describing a computer-implemented method 100. The computer-implemented method 100 is a method for trading combinations of financial instruments, sometimes referred to as combination trading or combo trading.

Action 110: An electronic combination order data message to trade financial instruments is received.

Action 120: The received electronic combination order data message is processed with an extended gcd algorithm to determine, or otherwise check, whether there exists a general solution for the received combination of financial instruments.

The present disclosure recognizes that the extended GCD algorithm may be advantageously applied to a received combination order. The inventor has also realized that a combination order can be described in terms of coefficients of the financial instruments it includes. An example of a combination order having two financial instruments may for example be expressed by the following formula:

a*x+b*y=c

The numbers a, b, x, y and c are all integer numbers. This formula has a solution if d=gcd (a,b) divides c. By applying an extended gcd algorithm three numbers can be found such that (d, s, t)=extgcd(a,b). From there these numbers a general solution can be found as:

x=v+mₓ, where kₓ=b/d, m_{x=s*c/d}

y=k_{y}*v+m_{y} where k_{y}=−a/d, m_{y}=t*c/d

Using these equations, and the allowed intervals for x and y it is further possible to find i) allowed values for v, which in turn gives ii) allowed values for x and y. As will be appreciated, formulas with more variables, e.g. a₀*x₀+aₙ*xₙ=c, may be solved in a similar way using factorization and recursion.

The inventor has realized that when applying an extended gcd algorithm on a received combination order it is possible to determine, or otherwise check, whether a general solution exists for the received combination of financial instruments.

Further illustrative examples will now be described herein below.

As been previously discussed, a general solution to a*x+b*y=c may be found by using the extended gcd algorithm. In a first example; 4*x+8*y=40. This formula has a solution if d=gcd(a,b) divides c. By applying an extended gcd algorithm three numbers can be found such that;

(d,s,t)=gcdex(a,b)=(4,1,0).

As d=4 divides 40, there accordingly are solutions:

x=kx*v+mx, where kx=b/d, mx=s*c/d

y=ky*v+my where ky=−a/d, my=t*c/d

x=(8/4)*v+1*40/4=2*v+10=2 v+10

y=(−4/4)*v+0*40/4=−1*v+0=−v,

v is an integer that can be chosen freely, see for example table 1 reproduced herein below:

| v = 0 | v = 5 | v = 10 |
|---|---|---|
| x = 2*0 + 10 = 10 | x = 2*5 + 10 = 20 | x = 2*10 + 10 = 30 |
| y = −0 = 0 | y = −5 = −5 | y = −10 = −10 |
| eq: 4*10 + 8*0 = 40 | eq: 4*20 + 8*(−5) = 40 | eq: 4*30 + 8*(−10) = 40 |

By using the equations above, a good v may be found, when given limits for x and y. As previously described; 4*x+8*y=40; x=2 v+10; and y=−v.

Assume for example that x should be within the range 15<x<18.

x=2v+10;

V(x)=(x−10)/2

V(15)>=(15−10)/2=5/2=3 (rounded up)

V(18)<=(18−10)/2=8/2=4

The number of valid solutions are accordingly V(18)-V(15)+1=4−3+1=2.

Table 2, reproduced herein below, illustrates the solutions for the equations when v=3 and v=4.

| v = 3 | v = 4 |
|---|---|
| x = 2*3 + 10 = 16 | x = 2*4 + 10 = 18 |
| y = −3 | y = −4 |
| eq: 4*16 + 8*(−3) = 64 − 24 = 40 | eq: 4*18 + 8*(−4) = 72 − 32 = 40 |

As has been described previously, equations with more variables, a₀*x₀+a₁*x₁+ . . . +aₙ*xₙ=c, may be solved in a similar way using factorization and recursion.

An extra variable may be added at the end, aₙ₊₁*xₙ₊₁, where aₙ₊₁=0. This does not change the equation. This allows to set a starting value for dₙ₊₁=0. However, it should be remembered that gcd(a,0)=a.

Starting from the end (at position n, not at n+1), it is possible to factorize the pairwise numbers according to their gcd, and make a variable substitution. It is then possible to use extgcd and recursively calculate (dₙ, sₙ, tₙ)=gcdex(aₙ, dₙ₊₁), and the factors (fₓₙ, f_{yn})=(aₙ/dₙ, dₙ₊₁/dₙ), and store them for later use. A factorization of the numbers may be performed, and the values required to create a linear combination of the numbers may be stored. Furthermore, it should be noted that gcd (fₓₙ, f_{yn})=1, as it has been divided by gcd already. This is because if d=gcd(a,b), then gcd(a/d, b/d)=1.

A pair of numbers (aₙ, dₙ₊₁) are effectively factorized to dₙ*(aₙ/dₙ, dₙ₊₁/dₙ). Logically, cₙ=((aₙ/dₙ)*xₙ+/dₙ)*xₙ+(dₙ₋₁/dₙ)*xₙ₊₁) may then be substituted. Thereafter, previous pairs may be continued to be factorized as (aₙ₋₁, dₙ) until d₀ is reached.

Logically, a sequence (list) of numbers may then be received: (d₀, s₀, t₀, a₀/d₀, d₁/d₀), (d₁, a₁/d₁, d₂/d₁), . . . , (dₙ, sₙ, tₙ, aₙ/dₙ, dₙ₊₁/dₙ)

If d₀ divides c, then there exists exact solution(s) to the equation. In that case, there will exist infinite number of solutions.

Hence:

d₀((a₀/d₀)*x₀+(d₁/d₀)*c₁)=c

And therefore, with c₀=c/d₀;

((a₀/d₀)*x₀+(d₁/d₀)*c₁)=c₀; note that it is already known how to solve the equation (a*x+b*y=c).

Similarly;

((a₁/d₁)*x₁+(d₂/d₁)*c₂)=c₁

((aₙ/dₙ)*xₙ+(dₙ₊₁/dₙ)*cₙ₊₁)=cₙ

Therefore it is possible to start and calculate x₀ and c₁ using the original equations. When c₁ is known, it is possible to calculate x₁ and c₂ and so on.

However, care should be taken when finding the solution to:

((aₙ/dₙ)*xₙ+(dₙ₊₁/dₙ)*cₙ₊₁)=cₙ.

The solution to a*x+b*y=c is (d,s,t)=gcdex(a,b), where d=gcd(a,b).

x=kₓ*v+mₓ, where kₓ=b/d, mₓ=s*c/d

y=k_{y}*v+m_{y} where k_{y}=−a/d, m_{y}=t*c/d

Therefore, it is possible to substitute a=(aₙ/ dₙ), and b=(dₙ₊₁/dₙ) to find the solution. However, d=gcd(a,b)=(aₙ/dₙ, dₙ₊₁/dₙ)=1, and accordingly, it is not necessary to divide with d in the final solution. Therefore, the solution becomes, with (fₓₙ, f_{yn})=(aₙ/dₙ, dₙ₊₁/dₙ),

xₙ=kₓₙ*vₙ+mₓₙ where kₓₙ=f_{yn}, mₓ=sₙ*cₙ

c₀=c/d₀

cₙ₊₁=k_{yn}*vₙ+m_{yn} where k_{y}=−fₓₙ, m_{y}=tₙ*cₙ

It should be noted that both cₙ₊₁ and xₙ will become vectors in this process.

Now, this will be illustrated with an example where 4*x₀+8*x₁+12*x₂=40 is going to be solved. In accordance with the above description, an extra variable may be added at the end,

aₙ₊₁*xₙ₊₁, where aₙ₊₁=0. Hence, the equation may be expressed as;

4*x₀+8*x₁+12*x₂+0*x₃=40.

By starting from the end (at position n=2), the pairwise numbers may be factorized according to their gcd, and a variable substitution can be made. d₃=0 is set.

Step 1, n=2;

(d₀, s₀, t₀)=gcdex(aₙ, dₙ₊₁),

(d₂, s₂, t₂)=gcdex(a₂, d₃)=gcdex(12, 0)=(12, 1, 0).

The numbers (dₙ, sₙ, tₙ, fₓₙ, f_{yn})=(dₙ, sₙ, tₙ, aₙ/dₙ, dₙ₊₁/dₙ)=(d₂, s₂, t₂, a₂/d₂, d₃/d₂)=(12, 1, 0, 12/12, 0/12)=(d₂, s₂, t₂, fₓ₂, f_{y2})=(12, 1, 0, 1, 0) are stored.

Thus,

$${4}^{*} {x}_{0} + {8}^{*} {x}_{1} + {12}^{*} {x}_{2} + {0}^{*} {x}_{3} = 40 = {4}^{*} {x}_{0} + {8}^{*} {x}_{1} + 12 ( {1}^{*} {x}_{2} + {0}^{*} {x}_{3} ) = 40.$$

$$Logically substitute {c}_{2} = {1}^{*} {x}_{2} + {0}^{*} {x}_{3} = {4}^{*} {x}_{0} + {8}^{*} {x}_{1} + {12}^{*} {c}_{2} = 40$$

Step 2, n=1

4*x₀+8*x₁+12*c₃=40

(dₙ, sₙ, tₙ)=gcdex(aₙ, dₙ₊₁),

(d₁, s₁, t₁)=gcdex(a₁, d₂)=gcdex(8, 12)=(4, −1, 1). It should be noted that d₂ is gcd from previous calculations.

Store the numbers (dₙ, sₙ, tₙ, fₓₙ, f_{yn})=(dₙ, sₙ, tₙ, aₙ/dₙ, dₙ₊₁/dₙ)=(d₁, s₁, t₁, a₁/d₁, d₂/d₁)=(4, −1, 1, 8/4, 12/4)

(d₁, s₁, t₁, fₓ₁, f_{y1})=(4, −1, 1, 2, 3).

Thus

$${4}^{*} {x}_{0} + {8}^{*} {x}_{1} + {12}^{*} {c}_{2} = 40 = {4}^{*} {x}_{0} + {4}^{*} ( {2}^{*} {x}_{1} + {3}^{*} {c}_{2} ) = 40.$$

$$Logically substitute {c}_{1} = {2}^{*} {x}_{1} + {3}^{*} {c}_{2} = {4}^{*} {x}_{0} + {4}^{*} {c}_{1} = 40$$

Step 3, n=0

4*x₀+4*c₂=40

(d₀, s₀, t₀)=gcdex(aₙdₙ₊₁),

(d₀, s₀, t₀)=gcdex(a₀, d₁)=gcdex(4, 4)=(4, 0, 1). It should be noted that d₁ is gcd from previous calculations.

Store the numbers (dₙ, sₙ, tₙ, aₙ/dₙ, dₙ₊₁/dₙ)=(d₀, s₀, t₀, a₀/d₀, d₁/d₀)=(4, 0, 1, 4/4, 4/4) (d₀, s₀, t₀, f₀, f_{y0})=(4, 0, 1, 1, 1).

Thus;

$${4}^{*} {x}_{0} + {4}^{*} {c}_{1} = 40 = {4}^{*} ( {x}_{0} + {c}_{1} ) = 40.$$

$$Logically substitute {c}_{0} = {x}_{0} + {c}_{1} = {4}^{*} {c}_{0} = 40 = c$$

It can be seen that there may be a solution if d₀=4 divides c=40. Since 40/4=10, with no remainder, this is the case. Accordingly, c₀=c/d₀=40/4=10 may be set.

The following sequences have been stored:

(d₀, s₀, t₀, f₀, f_{y0})=(4, 0, 1, 1, 1)

(d₁, s₁, t₁, fₓ₁, f_{y1})=(4, −1, 1, 2, 3)

(d₂, s₂, t₂, fₓ₂, f_{y2})=(12, 1, 0, 1, 0)

It is now possible to start solving x₀ and c₁.

x₀+c₁=c₀=10

Step 4, n=0

By using:

xₙ=kₓₙ*vₙ+mₓₙ where kₓₙ=f_{yn}, mₓ=sₙ*cₙ

c₀=c/d₀

cₙ₊₁=k_{yn}*vₙm_{yn} where k_{y}=−fₓₙ, m_{y}=tₙ*cₙ

Thus;

x₀=f_{y0}*v₀+s₀*c₀=(1)*v₀+(0*10)=1*v₀+0=v₀

c₁=−fₓ₀*v₀+t₀*c₀=(−1)*v₀+(1*10)=−1*v₀+10=−v₀+10

Since c₁ is known, it is possible to continue to solve x₁ and c₂.

The following sequences have been stored:

(d₁, s₁, t₁, fₓ₁, f_{y1})=(4, −1, 1, 2, 3)

(d₂, s₂, t₂, fₓ₂, f_{y2})=(12, 1, 0, 1, 0)

It is now possible to start to solve x₁ and c₂.

2*x₁+3*c₂=c₁=−1*v₀+10

Step 5, n=1

By using:

xₙ=kₓₙ*vₙ+mₓₙ where kₓₙ=f_{yn}, mₓ=sₙ*cₙ

Cₙ₊₁=k_{yn}*vₙ+yn where k_{y}=−fₓₙ, m_{y}=tₙ*cₙ

Thus;

x₁=f_{y1}*v₁+s₁*c₁=(3)*+v₁+(−1*(−1*v₀+10))=3* v₁+1*v₀−10=3 v₁+v₀−10

c₂=−fₓ₁*v₁+t₁*c₁=(−2)*v₁+(1*(−1* v₀+10))=−2*v₁−1*v₁+10=−2 v₁−v₀+10

Since C₂ is known, it is possible to continue to solve x₂ and c₃.

The following sequence has been stored:

(d₂, s₂, t₂, fₓ₂, f_{y2})=(12, 1, 0, 1, 0)

It is now possible to start to solve x₂ and x₃. It should be noted that x₃ is not needed, since this is a dummy variable and accordingly can be dropped.

1*x₂+0*x₃=c₂=−2*v₁+−1*v₀+10

Step 6, n=2

By using:

xₙ=kₓₙ*vₙ+mₓₙ where kₓₙ=f_{yn}, mₓ=sₙ*cₙ

cₙ₊₁=k_{yn}*vₙ+m_{yn} where k_{y}=−fₓₙ, m_{y}=tₙ*cₙ

Thus;

x₂=f_{y2}*v₂+s₂*c₂=(0)*v₂+(1*(−2*v₁+−1*v₀+10))=0*v₂−2*v₁−1*v₀+10=−2 v₁−v₀+10

x₃=c₃=−fₓ₂*v₂+t₂*c₂=(−1)*v₂+(0*(−1*v₀+10))=−1*v₁=−v₁

There are now solutions to all variables x₀, x₁ and x₂ (and x₃).

The general solution to 4*x₀+8*x₁+12*x₂=40 is accordingly;

x₀=v₀

x₁=3 v₁+v₀−10

x₂=−2 v₁−v₀+10

V₀ and v₁ are integers that may be chosen freely. See for example table 3 herein below:

| v₀ = 0 | v₀ = 5 | v₀ = 10 |
|---|---|---|
| v₁ = 0 | v₁ = 10 | v₁ = 10 |
| x₀ = 0 | x₀ = 5 | x₀ = 10 |
| x₁ = 3*0 + 0 − 10 = −10 | x₁ = 3*10 + 5 − 10 = 25 | x₁ = 3*10 + 10 − 10 = 30 |
| x₂ = −2*0 − 0 + 10 = 10 | x₂ = −2*10 − 5 + 10 = −15 | x₂ = −2*10 − 10 + 10 = −20 |
| eq: 4*0 + 8*(−10) + 12*10 = −80 + 120 = 40 | eq: 4*5 + 8*(25) + 12*(−15) = 40 | eq: 4*10 + 8*30 + 12*(−20) = 40 |

With continued reference to FIG. 1, the computer-implemented method 100 will now be described in further detail again. The computer-implemented method 100 may further comprise the following actions;

Action 130: If, or when, it is determined that there exists a general solution for the received combination of financial instruments and the received combination order is an eligible combination order for subsequent matching the received combination is stored.

Action 140: If, or when, it is determined that there does not exist a general solution for the received combination of financial instruments, the received combination order is cancelled or rejected.

As will be appreciated, received combination orders will only be stored (and thus accepted, or otherwise validated) as an eligible combination order for subsequent matching when it is determined that there exists a general solution for the received combination of financial instruments. Else, the received combination order is cancelled, or rejected. Hereby, the computer-implemented method will only store those combination orders which have a general solution and can be matched appropriately. By cancelling all other combination orders, the usage of processing resources can be limited. As a consequence, it is also possible to reduce the overall processing load.

Furthermore, by allowing subsequent processing of only eligible combination orders it is made possible to reduce the risk of matching combination orders at inaccurate pricing levels. Therefore, traders are generally not exposed to the risk of matched combination orders at disadvantageous pricing levels and, accordingly, the trading can improve for the traders.

Advantageously, but not necessarily, the above-mentioned method is implemented in a matching unit (sometimes referred to as matching engine) of an electronic automated exchange system.

In some embodiments, the method 100 further comprises:
extracting (Action 150), from the stored combination order, quality parameter(s) for each one of the N legs of the combination order;
determining (Action 160) a priority order for the subsequent processing of the N legs on the basis of the extracted quality parameter(s); and
processing (Action 170) the N legs in sequential order in accordance with the determined priority order to generate an estimated leg price for each one of the legs of the N legs.

The above-mentioned number N may be any integer of 1, 2, 3, 4, . . . , N. The higher N is, the more important the determination of priority order may become.

The above-mentioned quality parameter(s) may be any parameter indicating a quality of the leg in question. To this end, the quality parameter(s) may comprise one or more of the following examples: a price parameter, a spread parameter. The price parameter may for example include a theoretical price, a seed price, a National Bid Offer (NBO) and/or a National Best Bid Offer (NBBO). The spread parameter may include a theoretical spread, or an estimated spread. As used herein, spread is used to mean the price gap between a best-selling price and a best buying price (i.e., bid/ask).

The determination of leg price per se for each one of the N legs may be done in accordance with known techniques, such as leg price determining methods developed by Nasdaq. As an example, it is possible to utilize any of the combination leg price generation methods described in U.S. Pat. No. 7,698,205.

By determining a certain priority order of the stored (eligible) combination order, it may be possible to process all N legs relatively quickly to generate, or otherwise, determine the respective estimated leg prices. This may thus allow for an increasingly expedited generation of leg prices for N legs, especially when the combination orders are complex combination orders involving numerous legs.

In some embodiments, the above-mentioned actions 150, 160 and/or 170 may be performed by a matching unit of the electronic automated exchange system. In alternative embodiments, however, it is not necessary that these actions are performed by a matching unit of the automated exchange system. Instead, one or more of the actions 150, 160 and 170 can be performed by one or other devices or units that are separate and distinct from the matching unit. For example, the above-mentioned method 100 could be implemented in a distributed network of computing devices; e.g. such as a network Gateway. As an example, actions 110, 120, 130 and 140 could be performed by one computing device (e.g., a matching unit) and actions 150, 160 and 170 could be performed by one or more other computing devices (e.g., devices dedicated, and thus specifically configured for, combination order matching).

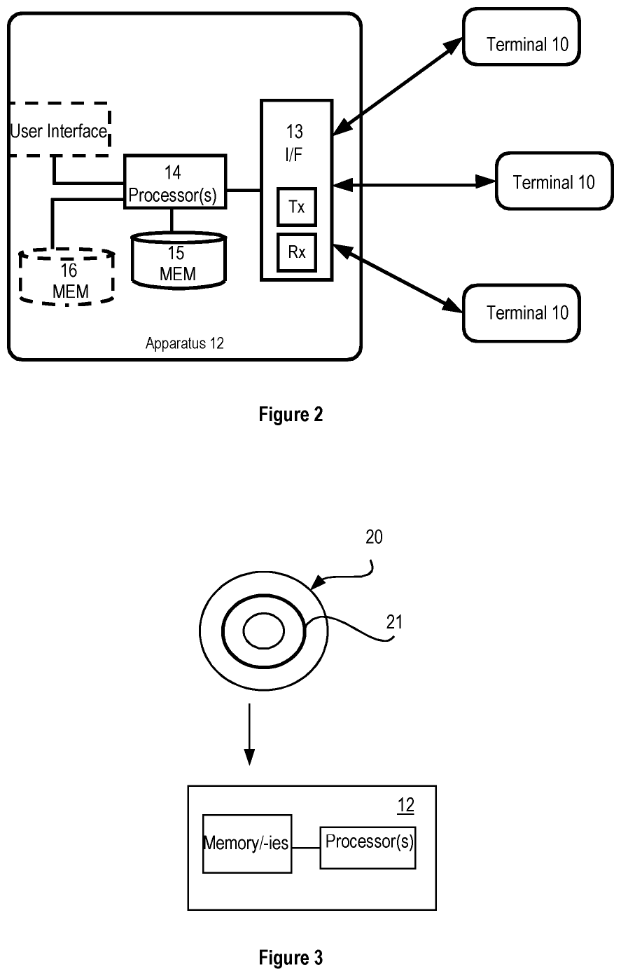

In FIG. 2, a general view of an electronic automated exchange system is shown, The system comprises a number of remote terminals 10 all connected to an apparatus 12, e.g. a central computer 12. The apparatus may comprise a communications interface (I/F) 13, a processor 14 and memory 15. The apparatus 12 may also be loaded with suitable software, e.g. provided by Nasdaq. The apparatus 12, when loaded with this suitable software, forms an automated electronic exchange system having features and functionality of an automated exchange. The terminals 10 are further designed to provide an interface for traders to trade contracts including combination contracts at the automated exchange.

The apparatus 12 is configured to implement the method as described in conjunction with FIG. 1.

In accordance with one embodiment, the memory 15 comprises instructions executable by the processor 14 whereby the apparatus 12 is operative to:
a) receive, via the communications interface 13, an electronic combination order data message to trade financial instruments;
b) processing, by the processor 14, the received electronic combination order data message with an extended gcd algorithm to determine whether there exists a general solution for the received combination of financial instruments;
c) storing, by a memory 16 (or 15), the received electronic combination order data message as an eligible combination order for subsequent matching when it is determined that there exists a general solution for the received combination of financial instruments; else
d) cancelling, by the processor 14, the received combination order when it is determined that there does not exist a general solution for the received combination of financial instruments.

The communications interface may comprise a transmitter (Tx) and/or a receiver (Rx). Alternatively, the communications interface may comprise a transceiver (Tx/Rx) combining transmission and reception capabilities.

In one embodiment, the memory 15 additionally comprises instructions executable by the processor 14 whereby the apparatus 12 is operative to:
e) extracting, by the processor 14, from the stored combination order, quality parameter(s) for each one of the N legs of the combination order;
f) determining, by the processor 14, a priority order for the subsequent processing of the N legs on the basis of the extracted quality parameter(s); quality parameter(s) for each one of the N legs of the combination order
g) processing, by the processor 14, the N legs in sequential order in accordance with the determined priority order to generate an estimated leg price for each one of the legs of the N legs.

Reference is now made to FIG. 3. FIG. 3 shows an example of a computer-readable medium, in this example in the form of a data disc 20. In one embodiment the data disc 20 is a magnetic data storage disc. The data disc 20 is configured to carry instructions 21 that can be loaded into a memory of an apparatus 12, e.g. a computer. Upon execution of said instructions by a processor of the apparatus 12, the apparatus 12 is caused to execute a method or procedure according to any one of the embodiments described herein in conjunction with FIG. 1. The data disc 20 is designed to be connected to or within and read by a reading device (not shown), for loading of the instructions into the processor. One such example of a reading device in combination with one (or several) data disc(s) 20 is a hard drive. It should be noted that the computer-readable medium can also be other mediums such as compact discs, flash memories or other memory technologies commonly used. In such an embodiment the data disc 20 is one type of a tangible computer-readable medium. The instructions may alternatively be downloaded to a computer data reading device, such as an apparatus 12 capable of reading computer coded data on a computer-readable medium, by comprising the instructions in a computer-readable signal (not shown) which is transmitted via a wireless (or wired) interface (for example via the Internet) to the computer data reading device for loading the instructions into a processor of the apparatus 12. In such an embodiment, the computer-readable signal is one type of a non-tangible computer-readable medium.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A computer-implemented method for trading combinations of financial instruments, the method comprising:
a) receiving an electronic combination order data message to trade the financial instruments indicated therein;
b) processing the received electronic combination order data message with an extended greatest common divisor, gcd, algorithm to determine whether there exists a general solution for the received combination of financial instruments;
c) storing the received electronic combination order data message as an eligible electronic combination order data message for subsequent matching by the matching engine when it is determined that there exists a general solution for the received combination of financial instruments; else d) cancelling the received electronic combination order data message when it is determined that there does not exist a general solution for the received combination of financial instruments.

2. The method according to claim 1, wherein the method further comprises:
e) extracting, from the stored electronic combination order data message, quality parameter(s) for each one of the N legs of the combination order message;
f) determining a priority order for the subsequent processing of the N legs on the basis of the extracted quality parameter(s); and
g) processing the N legs in sequential order in accordance with the determined priority order, generating an estimated leg price for each one of the N legs.

3. The method according to claim 2, wherein the quality parameter(s) comprises one or more of the following: a price parameter, a spread parameter.

4. The method according to claim 3, wherein the price parameter includes a theoretical price.

5. The method according to claim 3, wherein the price parameter includes a seed price.

6. The method according to claim 3, wherein the price parameter includes a National Bid Offer, NBO.

7. The method according to claim 3, wherein the price parameter includes a National Best Bid Offer, NBBO.

8. The method according to claim 3, wherein the spread parameter includes a theoretical spread.

9. The method according to claim 3, wherein the spread parameter includes an estimated spread.

10. The method according to claim 1 wherein the method is implemented in a matching unit of an automated electronic exchange system.

11. The method according to claim 1, wherein the method is implemented in a distributed network of computing devices.

12. The method according to claim 11, wherein the method steps a) trough d) is performed by one computing device and the method steps e) through g) is performed by one or more other computing devices.

13. An apparatus for trading combinations of financial instruments, wherein the apparatus comprises a communications interface, a processor, and a memory comprising instructions executable by the processor whereby the apparatus is operative to:
a) receive, via the communications interface, an electronic combination order data message to trade financial instruments;
b) processing, by the processor, the received electronic combination order data message with an extended greatest common divisor, gcd, algorithm to determine whether there exists a general solution for the received combination of financial instruments;
c) storing, by a memory, the received electronic combination order data message as an eligible combination order for subsequent matching when it is determined that there exists a general solution for the received combination of financial instruments; else
d) cancelling, by the processor, the received electronic combination order data message when it is determined that there does not exist a general solution for the received combination of financial instruments.

14. The apparatus according to claim 13, wherein the communications interface comprises a transmitter, Tx, and/or a receiver Rx.

15. The apparatus according to claim 13, wherein the communications interface comprises a transceiver, Tx/Rx.

16. The apparatus according to claim 13, wherein the memory additionally comprises instructions executable by the processor whereby the apparatus is operative to:
e) extracting, by the processor, from the stored electronic combination order data message, quality parameter(s) for each one of the N legs of the combination order;
f) determining, by the processor, a priority order for the subsequent processing of the N legs on the basis of the extracted quality parameter(s); quality parameter(s) for each one of the N legs of the combination order; and
g) processing, by the processor, the N legs in sequential order in accordance with the determined priority order to generate an estimated leg price for each one of the legs of the N legs.

17. The apparatus according to claim 13, wherein the apparatus is implemented as a matching unit of an automated exchange system.

18. A non-transitory computer readable storage medium storing one or more sets of instructions for causing a processor to perform the method according to claim 1.
